(19) United States
(12) Patent Application Publication
(10) Pub. No.: US 2025/0329045 A1
(43) Pub. Date: Oct. 23, 2025

(54) VISUAL LOCALIZATION METHOD USING 3D RAY CLOUDS AND APPARATUS FOR EXECUTING THE SAME

(71) Applicant: IUCF-HYU (INDUSTRY-UNIVERSITY COOPERATION FOUNDATION HANYANG UNIVERSITY), Seoul (KR)

(72) Inventors: Je Hyeong HONG, Seoul (KR); Hee Joon MOON, Seoul (KR); Chung Hwan LEE, Yongin-si (KR)

(21) Appl. No.: 19/070,564

(22) Filed: Mar. 5, 2025

Related U.S. Application Data
(63) Continuation of application No. PCT/KR2024/007509, filed on May 31, 2024.

(30) Foreign Application Priority Data
Apr. 18, 2024 (KR) 10-2024-0052143

(51) Int. Cl. G06T 7/73; G06T 17/00; G06V 10/44; G06V 10/762

(52) U.S. Cl. CPC G06T 7/73; G06T 17/00; G06V 10/44; G06V 10/762

(57) ABSTRACT

According to one embodiment of the present disclosure, A visual localization method comprises generating at least two or more anchor points from three-dimensional point clouds; generating three-dimensional ray clouds by connecting three-dimensional points included in the three-dimensional point clouds with one of the generated anchor points; extracting feature points of an input image; and clustering a plurality of lines included in the three-dimensional ray clouds based on the at least two or more anchor points, sampling two ray cloud clusters out of the clustered ray cloud clusters, and estimating a pose of a camera that captured the input image based on the sampled ray cloud clusters and the feature points.

### TECHNICAL FIELD

The disclosure relates to a visual localization method using 3D ray clouds that can increase the calculation speed of a visual localization algorithm while preventing the leakage of personal information, and an apparatus for executing the same.

### BACKGROUND

As the frequency of use and demand for augmented reality (AR), virtual reality (VR), mixed reality (MR), autonomous vehicles, autonomous guide robots, etc., which have emerged with the fourth industrial revolution, increase, there has been a need for more precise user location estimation technologies. Global navigation satellite systems (GNSSs) such as existing GPS are difficult to apply indoors and have a margin of error, resulting in limitations that make them unsuitable for application in the relevant industrial environments. As a technology to replace this, visual localization technology is attracting attention.

The visual localization technology is a technology that identifies the exact location and pose of a user device on a spatial map based on images via a camera, and can exhibit high location identification accuracy at a relatively low cost with the widespread use of camera sensors. Products equipped with visual localization technology transmit a query image to a cloud server, compare it with the stored three-dimensional point cloud spatial map, and then estimate the location and pose of the user's camera. However, since pieces of feature information are stored together inside the three-dimensional point cloud map stored in the cloud server, the point clouds can be synthesized into an image similar to the real one (reverse reconstruction) via a deep learning model (e.g., Inverse Structure-from-Motion, InvSfM) when the spatial map is leaked. Therefore, when the three-dimensional map stored in the cloud server is leaked, sensitive personal information of users can be leaked.

In order to resolve this issue, by using randomly oriented three-dimensional straight lines passing through points, i.e., a geometrically concealed three-dimensional spatial map instead of using a three-dimensional point cloud spatial map, a technique for estimating the location and pose of a user's device was proposed (hereinafter, Prior Art Literature 1). However, as it was found that the reconstruction of point clouds from randomly oriented line clouds was possible for such a technique as well (hereinafter, Prior Art Literature 2), privacy concerns have been raised again.

Prior Art Literature 3, published in 2023, proposed a method of generating a three-dimensional line cloud map by introducing a way of randomly selecting two points and connecting them with a line, and showed high concealment performance compared to the previously disclosed three-dimensional uniform line cloud map.

(Prior Art Literature 1) P. Speciale et al., “Privacy preserving image queries for camera localization”, ICCV, 2019.

(Prior Art Literature 2) K. Chelani et al., “How Privacy-Preserving Are Line Clouds? Recovering Scene Details From 3D Lines”, ICCV, 2021.

(Prior Art Literature 3) C. Lee et al., “Paired-Point Lifting for Enhanced Privacy-Preserving Visual Localization”, ICCV, 2023.

Further, Prior Art Patent 1 has been disclosed for a method of estimating the pose of a camera based on line clouds. Prior Art Patent 1 proposes a method of generating line clouds, and discloses in particular connecting an anchor point with all three-dimensional points. However, Prior Art Patent 1 does not clearly disclose how to set an anchor point, and has a problem that the estimation performance deteriorates when the estimation of the pose of the camera is performed by using a random anchor point.

(Prior Art Patent 1) U.S. Pat. No. 10,964,053 B2

### SUMMARY

### Technical Objects

In order to solve these problems, one disclosed embodiment proposes a method of setting an anchor point that protects privacy information by reducing the accuracy of reverse reconstruction to point clouds and at the same time does not degrade the performance of estimating the pose of a camera, a method of generating ray clouds using the same, and an apparatus for executing the same.

### Technical Solution

According to one embodiment of the present disclosure, A visual localization method comprises generating at least two or more anchor points from three-dimensional point clouds; generating three-dimensional ray clouds by connecting three-dimensional points included in the three-dimensional point clouds with one of the generated anchor points; extracting feature points of an input image; and clustering a plurality of lines included in the three-dimensional ray clouds based on the at least two or more anchor points, sampling two ray cloud clusters out of the clustered ray cloud clusters, and estimating a pose of a camera that captured the input image based on the sampled ray cloud clusters and the feature points.

The generating the anchor points comprises storing a setting command for the number of the anchor points to be generated; generating clusters as many as the number of the anchor points from the three-dimensional point clouds; extracting center points of the generated clusters; and generating the extracted center points as the anchor points.

The generating the anchor points comprises setting a three-dimensional space region in which anchor points exist from the three-dimensional point clouds; sampling candidate anchor points; and generating the anchor points based on whether the candidate anchor points exist in the three-dimensional space region.

The setting the three-dimensional space region comprises calculating three basis axes and variances for the basis axes based on principal component analysis of the three-dimensional point clouds; and setting the three-dimensional space region based on the calculated variances.

The setting the three-dimensional space region comprises calculating a centroid of a three-dimensional point included in the three-dimensional point clouds; and setting the three-dimensional space region by setting a distance between the centroid and the three-dimensional point as a radius.

The sampling the candidate anchor points comprises selecting a random three-dimensional point from the three-dimensional point clouds; or sampling the candidate anchor points based on three-dimensional coordinate values generated through random number generation.

The generating the three-dimensional ray clouds comprises pairing one three-dimensional point randomly selected from the three-dimensional points included in the three-dimensional point clouds with one of the at least two or more anchor points; generating a line connecting the paired three-dimensional point and anchor point with each other; and deleting the three-dimensional point from which the line was generated.

The generating the three-dimensional ray clouds comprises dividing the three-dimensional point clouds into a plurality of subspace regions having a preset size; pairing all three-dimensional points included in one of the subspace regions with one of the at least two or more anchor points; generating lines connecting the paired three-dimensional points and anchor point; and deleting the three-dimensional points from which the lines were generated.

The ray cloud clusters are characterized in that the one anchor point intersects at least five or more lines.

According to another embodiment of the present disclosure, a server comprises a processor; and a memory configured to store a program for operating the processor and three-dimensional point clouds received from outside, wherein the processor: generates at least two or more anchor points from the three-dimensional point clouds, generates three-dimensional ray clouds by connecting three-dimensional points included in the three-dimensional point clouds with one of the generated anchor points; clusters a plurality of lines included in the three-dimensional ray clouds based on the at least two or more anchor points, samples two ray cloud clusters out of the clustered ray cloud clusters, and estimates a pose of a camera that captured the input image based on the sampled ray cloud clusters and feature points of an input image.

The processor receives a setting command for the number of the anchor points, generates clusters as many as the number of the anchor points from the three-dimensional point clouds, extracts center points of the generated clusters, and generates the extracted center points as the anchor points, or sets a three-dimensional space region in which anchor points exist from the three-dimensional point clouds, samples candidate anchor points, and generates the anchor points based on whether the candidate anchor points exist in the three-dimensional space region.

The processor calculates three basis axes and variances for the basis axes based on principal component analysis of the three-dimensional point clouds, and sets the three-dimensional space region based on the calculated variances, or calculates a centroid of a three-dimensional point included in the three-dimensional point clouds, and sets the three-dimensional space region by setting a distance between the centroid and the three-dimensional point as a radius, and selects a random three-dimensional point from the three-dimensional point clouds, or samples the candidate anchor points based on three-dimensional coordinate values generated through random number generation.

The processor pairs one three-dimensional point randomly selected from the three-dimensional points included in the three-dimensional point clouds with one of the at least two or more anchor points, generates a line connecting the paired three-dimensional point and anchor point with each other, and deletes the three-dimensional point from which the line was generated.

The processor divides the three-dimensional point clouds into a plurality of subspace regions having a preset size, pairs all three-dimensional points included in one of the subspace regions with one of the at least two or more anchor points, generates lines connecting the paired three-dimensional points and anchor point with each other, and deletes the three-dimensional points from which the lines were generated.

According to the other embodiment of the present disclosure, A system comprises a user terminal configured to capture an input image; and a server configured to communicate with the user terminal, wherein the server: generates at least two or more anchor points from three-dimensional point clouds, generates three-dimensional ray clouds by connecting three-dimensional points included in the three-dimensional point clouds with one of the generated anchor points, and clusters a plurality of lines included in the transmitted three-dimensional ray clouds based on the at least two or more anchor points, and samples at least two ray cloud clusters out of the clustered ray cloud clusters, and wherein the user terminal: detects feature points of the input image, and estimates a pose of a camera that captured the input image based on the detected feature points, the at least two or more anchor points set as a center of a pinhole camera model, and the sampled ray cloud clusters.

### Effects of the Disclosure

As a result, the disclosed visual localization method based on 3D ray clouds and the apparatus for executing the same show a higher calculation speed than the conventional single-image visual localization algorithm using line clouds, and can thus be applied to various products requiring real-time calculations.

In particular, the disclosed embodiments are applicable to products in which real-time visual localization for immediate interaction with the surrounding environment is essential, such as in the fields of autonomous driving and robotics, and can maintain high spatial information security by preventing attempts to reconstruct three-dimensional point clouds from a three-dimensional ray cloud map.

### BRIEF DESCRIPTION OF THE DRAWINGS

FIG. 1 is a diagram for schematically describing a system for executing a disclosed visual localization method;

FIG. 2a is a control block diagram of a system according to one disclosed embodiment;

FIG. 2b is a control block diagram of a system according to another disclosed embodiment;

FIG. 3 is an overall flowchart of the disclosed visual localization method;

FIG. 4 is a flowchart for specifically describing a first embodiment of the step of generating the anchor points;

FIG. 5 is a flowchart for specifically describing a second embodiment of the step of generating the anchor points;

FIG. 6 is a diagram for describing a first embodiment of setting a three-dimensional space region;

FIG. 7 is a diagram for describing a second embodiment of setting a three-dimensional space region;

FIGS. 8a and 8b are a diagram for describing a basis for setting a three-dimensional space region;

FIG. 9 is a flowchart for specifically describing the step of sampling the candidate anchor points included in FIG. 5;

FIG. 10 is a diagram showing one example in which ray clouds have been generated based on point clouds;

FIG. 11 is a flowchart for describing a specific method of generating ray clouds;

FIG. 12 is a diagram for describing a first embodiment of generating ray clouds;

FIG. 13 is a diagram for describing a second embodiment of generating ray clouds;

FIG. 14 is a flowchart for describing a specific method of performing pose estimation of a camera;

FIG. 15 is a diagram for specifically describing the disclosed visual localization method;

FIG. 16 is a diagram for comparing the ray clouds generated by each embodiment according to the same input image; and

FIG. 17 is a table for describing the effect of the disclosed visual localization method.

### DETAILED DESCRIPTION OF EMBODIMENTS

The embodiments described in this specification and the configurations illustrated in the drawings represent merely preferred examples of the disclosed invention. As of the filing date of this application, various modifications and substitutions for the embodiments and drawings disclosed herein may exist.

Throughout this specification, when an element is described as being positioned ‘on’ another element, it includes both cases where the one element is directly on the other element and cases where additional elements may be interposed between them.

Additionally, the terms used in this specification are intended to describe the embodiments and are not intended to limit and/or restrict the scope of the disclosed invention. Unless explicitly stated otherwise, singular expressions include their plural forms. In this specification, terms such as ‘comprise’ or ‘have’ are intended to indicate the presence of features, numbers, steps, actions, components, parts, or combinations thereof as described in the specification, but do not preclude the presence or addition of one or more other features, numbers, steps, actions, components, parts, or combinations thereof.

Additionally, terms such as ‘first’ and ‘second,’ which include ordinals, may be used in this specification to describe various components. However, these components are not limited by these terms, which are used solely to distinguish one component from another. For example, without departing from the scope of the present invention, a ‘first’ component may be referred to as a ‘second’ component, and similarly, a ‘second’ component may be referred to as a ‘first’ component.

Hereinafter, embodiments of the present invention will be described in detail with reference to the accompanying drawings.

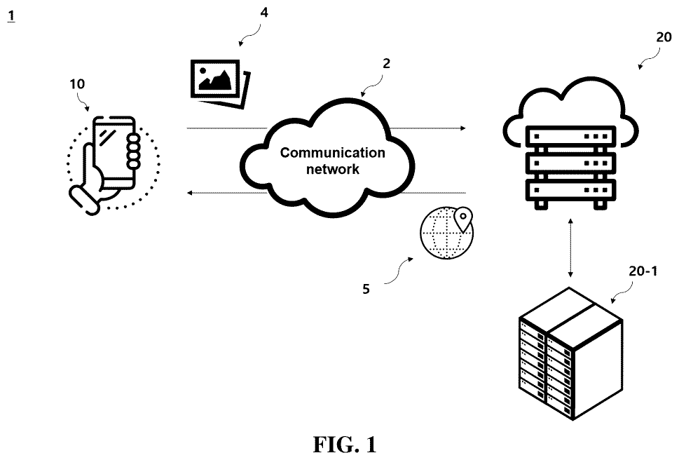

FIG. 1 is a diagram for schematically describing a system for executing a disclosed visual localization method.

Referring to FIG. 1, a system 1 for executing a visual localization method according to one disclosed embodiment may include a user terminal 10, a server 20, and a communication network 2 connecting the user terminal 10 and the server 20.

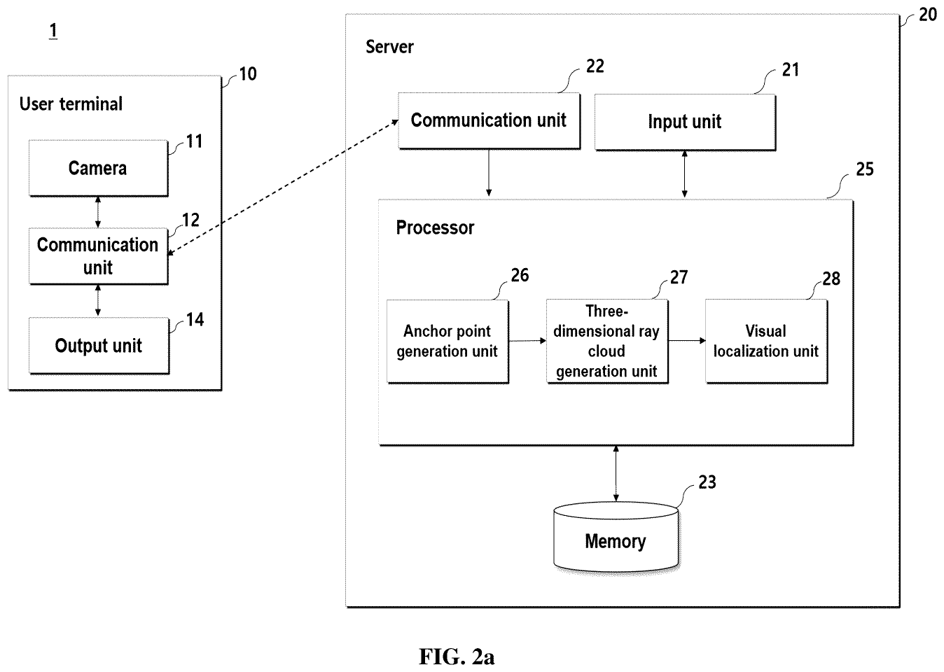

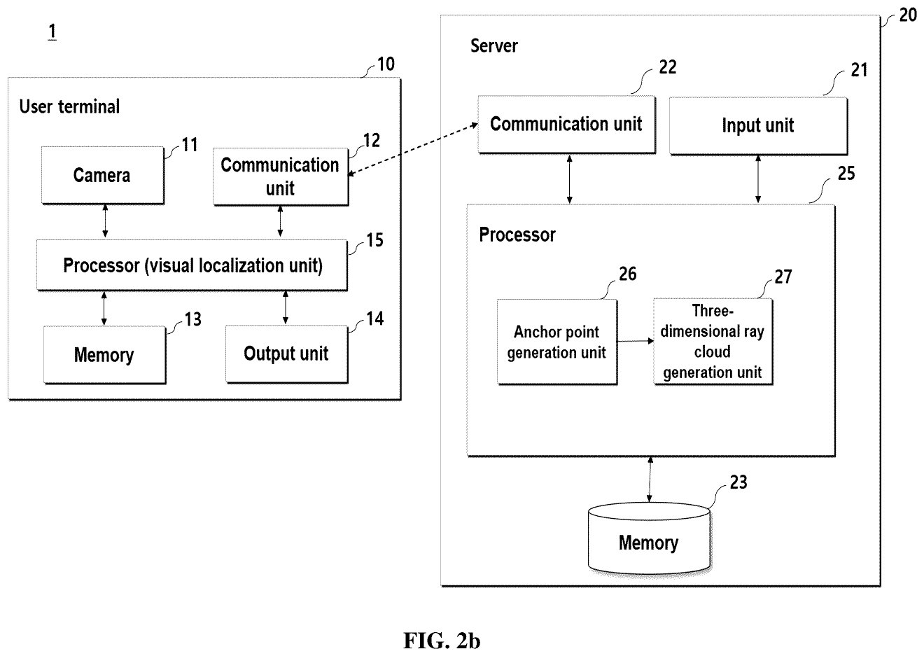

The user terminal 10 obtains an image 4 (hereinafter, an input image (or query image)) captured by a camera 11 (see FIG. 2b). The user terminal 10 may transmit the input image or feature points detected in the input image to the server 20. According to one embodiment, the server 20 may perform pose estimation of the camera 11 based on the input image transmitted by the user terminal 10. According to another embodiment, the user terminal 10 may estimate the pose of the camera 11 on its own after exchanging data with the server 20.

The server 20 has three-dimensional point clouds stored therein in advance and converts the three-dimensional point clouds into three-dimensional ray clouds. The server 20 according to one embodiment may estimate the pose of the camera 11 that captured the input image 4 by matching the feature points of the input image transmitted by the user terminal 10 with the three-dimensional ray clouds. The server 20 transmits the estimation result 5 back to the user terminal 10.

The user terminal 10 may be implemented as a computer or a portable terminal that can be connected to the communication network 2. Here, the computer may include, for example, a desktop computer, a laptop computer, a tablet PC, a slate PC, etc., equipped with a web browser, and the portable terminal is, for example, a wireless communication device that ensures portability and mobility, and may include any kind of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminals, smartphones, etc., and wearable devices, such as eyeglasses, contact lenses, or head-mounted devices (HMDs).

The communication network 2 is a passage for transmitting the ray clouds or the pose estimation result 5 of the camera 11 between the user terminal 10 and the server 20. The pose estimation result 5 is map coordinates including latitude and longitude, and may be expressed in a format such as decimal degrees (DD), degrees, minutes, and seconds (DMS), degrees and decimal minutes (DMM), or the like.

The server 20 is a component that stores a large amount of map data that allows for performing pose estimation of the camera. The server 20 may be implemented in the form of a cloud server to which an unlimited number of users can surely request access in a cloud computing environment. The server 20 may be configured with a processor 25 (see FIGS. 2a-2b) that converts a large amount of three-dimensional point clouds into three-dimensional ray clouds and performs pose estimation of the camera 11 through the three-dimensional ray clouds, and a memory 23 (see FIGS. 2a-2b) that stores the large amount of data described above, and may also be implemented in a form that can be directly connected to the three-dimensional point clouds via an external processor 20-1, etc.

FIG. 2a is a control block diagram of a system according to one disclosed embodiment.

Referring to FIG. 2a, the user terminal 10 according to the one disclosed embodiment may include, hardware-wise, a camera 11 that captures an input image, a communication unit 12 that performs communication with a communication unit 22 of the server 20 via the communication network 2, an output unit 14 that displays the input image captured by the camera 11 or outputs a pose estimation result of the camera 11 transferred by the server 20.

Specifically, the camera 11 may include a variety of imaging means, such as a CMOS (Complementary Metal-Oxide Semiconductor) image sensor and a CCD (Charge-Coupled Device) image sensor.

The communication unit 12 may include one or more components that enable communication with the communication network 2, and may include, for example, at least one of a short-range communication module, a wired communication module, and a wireless communication module.

The short-range communication module may include a variety of short-range communication modules that transmit and receive signals using a wireless communication network in a short range, such as a Bluetooth module, an infrared communication module, an RFID (Radio Frequency Identification) communication module, a WLAN (Wireless Local Access Network) communication module, an NFC communication module, and a Zigbee communication module.

The wired communication module may include a variety of wired communication modules, such as a Local Area Network (LAN) module, a Wide Area Network (WAN) module, or a Value-Added Network (VAN) module, as well as a variety of cable communication modules, such as USB (Universal Serial Bus), HDMI (High-Definition Multimedia Interface), DVI (Digital Visual Interface), RS-232 (Recommended Standard 232), power line communication, or POTS (plain old telephone service).

The wireless communication module may include a wireless communication module that supports various wireless communication methods, such as GSM (Global System for Mobile Communication), CDMA (Code Division Multiple Access), WCDMA (Wideband Code Division Multiple Access), UMTS (Universal Mobile Telecommunications System), TDMA (Time Division Multiple Access), and LTE (Long Term Evolution), in addition to a Wi-Fi module and a Wireless Broadband module.

The output unit 14 outputs the pose estimation result 5 of the camera 11, which is transferred by a display that displays the input image and the server 20. To this end, the output unit 14 may be provided as, but is not limited to, a digital light processing (DLP) panel, a plasma display panel, a liquid crystal display (LCD) panel, an electroluminescence (EL) panel, an electrophoretic display (EPD) panel, an electrochromic display (ECD) panel, a light-emitting diode (LED) panel, an organic light-emitting diode (OLED) panel, or the like.

The user terminal 10 may further include various components in addition to the components shown in FIGS. 2a-2b, and is not limited to the names referring to the components.

The server 20 includes an input unit 21 that receives input commands of a user, a communication unit 22 that performs communication with the user terminal 10, a memory 23 that stores input images received by the communication unit 22 or stores large amounts of data and algorithms required to execute the disclosed visual localization method, and a processor 25 for controlling each component of the server 20.

Specifically, the input unit 21 receives a setting command for the number of anchor points required to generate three-dimensional ray clouds. To this end, the input unit 11 may include hardware devices, such as various buttons or switches, a keyboard, a mouse, a trackball, various levers, a handle, a stick, or the like that are connected to the server 20 and that can receive a setting commands from the user. In addition, the input unit 11 may include a GUI (graphical user interface), i.e., a device that is software, such as a touchpad or the like. The touchpad may be implemented with a touchscreen panel (TSP) and may form an interlayer structure with the display.

The memory 23 may be implemented with at least one of a nonvolatile memory element such as cache, ROM (read-only memory), PROM (programmable ROM), EPROM (erasable programmable ROM), EEPROM (electrically erasable programmable ROM), and flash memory, or a volatile memory element such as RAM (random access memory), or a storage medium such as a hard disk drive (HDD) and CD-ROM, but is not limited thereto. The memory 23 may be a memory implemented as a separate chip from the processor 25 described later, or may be implemented as a single chip with the processor 25.

The processor 25 is a component that performs the disclosed visual localization method while controlling the hardware included in the server 20. To this end, the processor 25 may refer to a data processing device built into the hardware, which has a physically structured circuit to perform functions represented by code or commands included in a program. The processor 25 may encompass, but is not limited to, processing devices, such as a microprocessor, a central processing unit (CPU), a processor core, a multiprocessor, an application-specific integrated circuit (ASIC), a field programmable gate array (FPGA), or a graphics processing unit (GPU), as examples of a data processing device built into the hardware. The processor 25 may include one or more processors.

The processor 25 may be divided, software-wise, into an anchor point generation unit 26 that generates at least two or more anchor points from the three-dimensional point clouds, a three-dimensional ray cloud generation unit 27 that generates three-dimensional ray clouds by connecting three-dimensional points included in the three-dimensional point clouds with one of the generated anchor points, and a visual localization unit 28 that estimates the pose of the camera 11 that captured the input image based on the generated three-dimensional ray clouds. The processor 25 transmits the pose estimation result generated by the visual localization unit 28 to the user terminal 10 via the communication unit 22.

A specific description of the operation of the processor 25 divided software-wise will be given later with reference to other drawings below.

Further, the server 20 may omit some of the components described above in FIG. 2a. For example, the server 20 may be configured only with the processor 25 and the memory 23, or may be provided with a plurality of chips each of which implements the processor 25 and the memory 23.

FIG. 2b is a control block diagram of a system according to another disclosed embodiment. Descriptions of components that overlap with those shown in FIG. 2a will be omitted.

Referring to FIG. 2b, a user terminal 10 according to another disclosed embodiment may include, hardware-wise, a camera 11 that captures an input image, a communication unit 12 that performs communication with a communication unit 22 of a server 20 via a communication network 2, a processor 15 that controls the overall user terminal 10, performs image processing of the input image captured by the camera 11, receives three-dimensional ray clouds transferred by the server 20, and performs pose estimation of the camera 11, an output unit 14 that displays the input image captured by the processor 15 or outputs a pose estimation result performed by the processor 15, and a memory 13 that stores various data necessary for the operation of the processor 15.

Unlike the embodiment described in FIG. 2a, the system 1 according to the embodiment of FIG. 2b can allow the processor 15 to perform a visual localization process, i.e., pose estimation of the camera 11. To this end, the processor 15 may receive three-dimensional ray clouds via the server 20. The processor 15 may perform pose estimation of the camera by extracting feature points from the input image captured by the camera 11 and then matching the extracted feature points with the three-dimensional ray clouds received from the server 20. The method of performing the pose estimation of the camera in this way is the same as the operation method of the visual localization unit 28 of the server 20 described above in FIG. 2a, and the difference lies only in the entity that performs the visual localization.

Further, the user terminal 10 according to the embodiment of FIG. 2b may be provided with the processor 15 and the memory 13 on the same chip, and may further include components other than those shown in FIG. 2b, or some of the components may be omitted.

In the following, a visual localization method that can be executed in both the embodiments of FIGS. 2a and 2b will be specifically described.

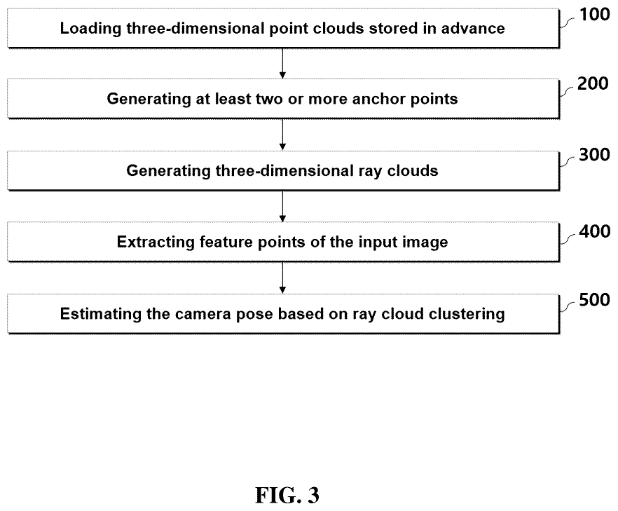

FIG. 3 is an overall flowchart of the disclosed visual localization method.

Referring to FIG. 3, the system 1 that performs the disclosed visual localization method loads three-dimensional point clouds (100).

Here, the three-dimensional point clouds are a large amount of map data prepared in advance to determine where the input image captured by the camera 11, whose pose is to be estimated, was captured. The three-dimensional point clouds may be stored in advance in the memory 23 of the server 20, and may be loaded from the memory 23 when a request is received from the user terminal 10.

The system 1 generates at least two or more anchor points from the three-dimensional point clouds (200).

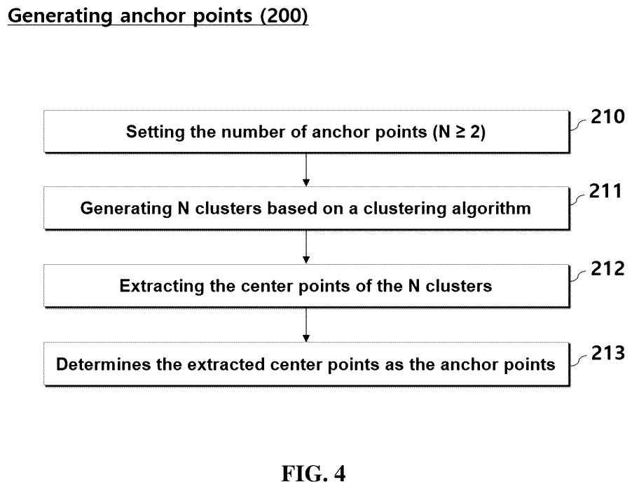

The disclosed visual localization method must generate at least two anchor points, and can generate three or more anchor points as well. In addition, when generating at least two anchor points, the system 1 sets a three-dimensional space region in which anchor points may exist, and samples candidate anchor points within the three-dimensional space region. A specific method of generating anchor points will be described in detail later through FIG. 4 and subsequent figures.

The system 1 generates three-dimensional ray clouds by connecting the at least two or more anchor points generated with three-dimensional points included in the three-dimensional point clouds (300).

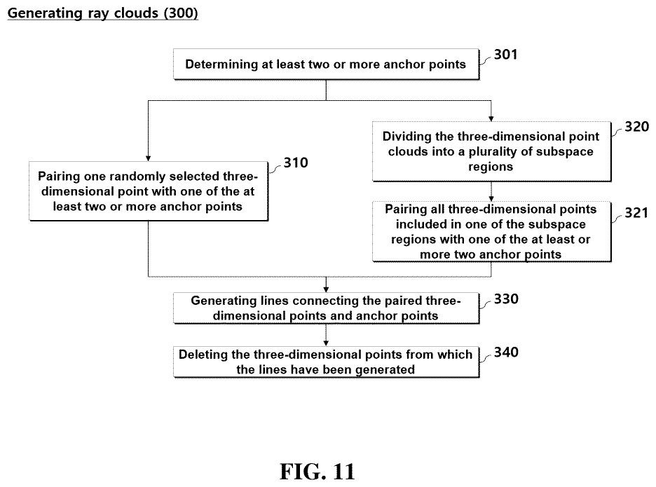

Specifically, the system 1 generates three-dimensional ray clouds by pairing the anchor points with the three-dimensional points and then generating lines based on the paired points. A specific method of generating three-dimensional ray clouds will described in detail later through FIG. 11 and subsequent figures.

Feature points of the input image are extracted (400).

Here, the feature points are the result detected by the user terminal 10 from the input image. According to the embodiment of FIG. 2a, the user terminal 10 may generate feature information in the process of detecting the feature points and transmit the feature information to the server 20.

If the pose estimation of the camera 11 is performed by the user terminal 10 according to the embodiment of FIG. 2b, the server 20 does not receive the feature points from the user terminal 10 but rather transmits the generated three-dimensional ray clouds to the user terminal 10. The user terminal 10 extracts the feature points of the input image after receiving the three-dimensional ray clouds. The user terminal 10 performs the following operations based on the extracted feature points and the received three-dimensional ray clouds.

The system 1 clusters the generated three-dimensional ray clouds and estimates the pose of the camera 11 based on the clustered ray clouds (500).

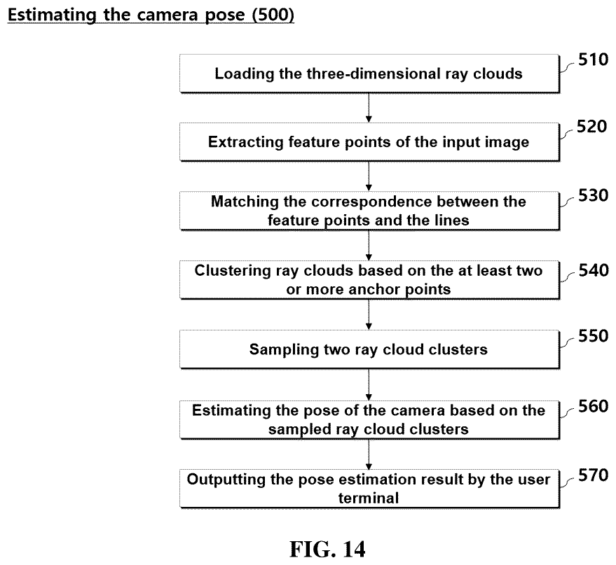

A specific method of estimating the pose of the camera 11 based on the clustered ray clouds will be described in detail below through FIG. 14.

FIG. 4 is a flowchart for specifically describing a first embodiment of the step of generating the anchor point.

Referring to FIG. 4, the system 1 receives an input command for the user to set the number of anchor points (210).

Specifically, the system 1 may receive an input command for the number of anchor points to be generated from the user through various methods. However, the system 1 may receive an input command from the user for the generation of at least two or more anchor points.

When the user transfers the input command for the number of anchor points, the system 1 generates N clusters based on a clustering algorithm (211).

Here, the number N corresponds to the number of anchor points input from the user. The N clusters may be generated by a general clustering algorithm (e.g., K-means clustering algorithm).

The system 1 extracts the center points of the N clusters (212) and determines the extracted center points as the anchor points (213).

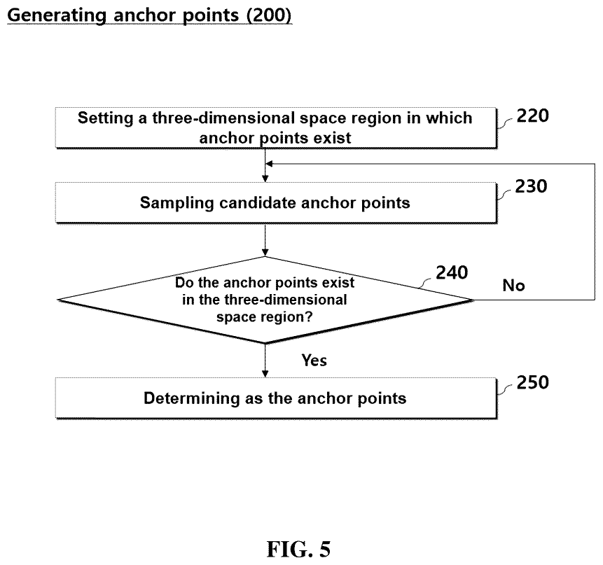

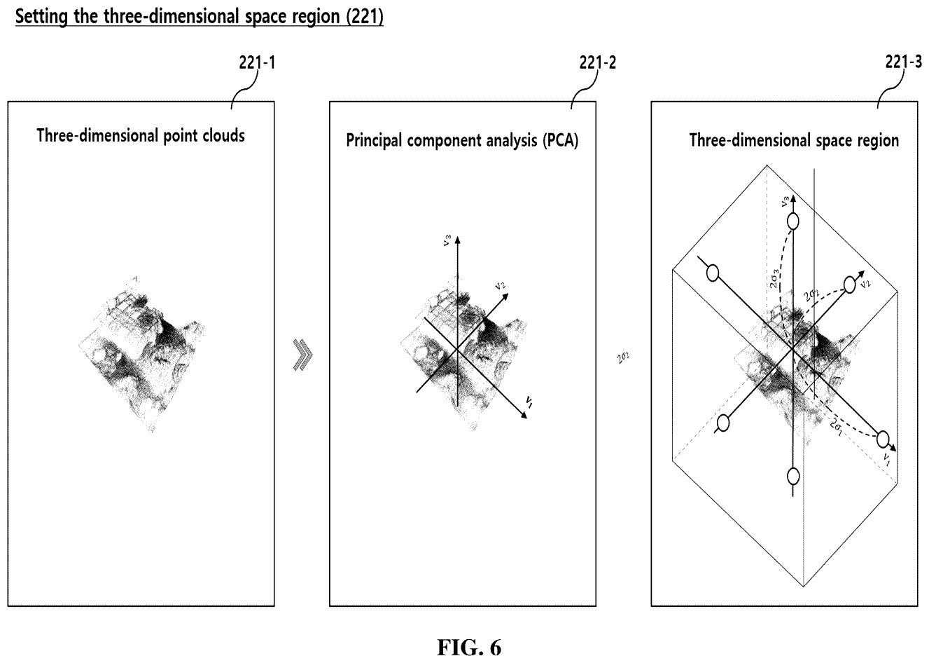

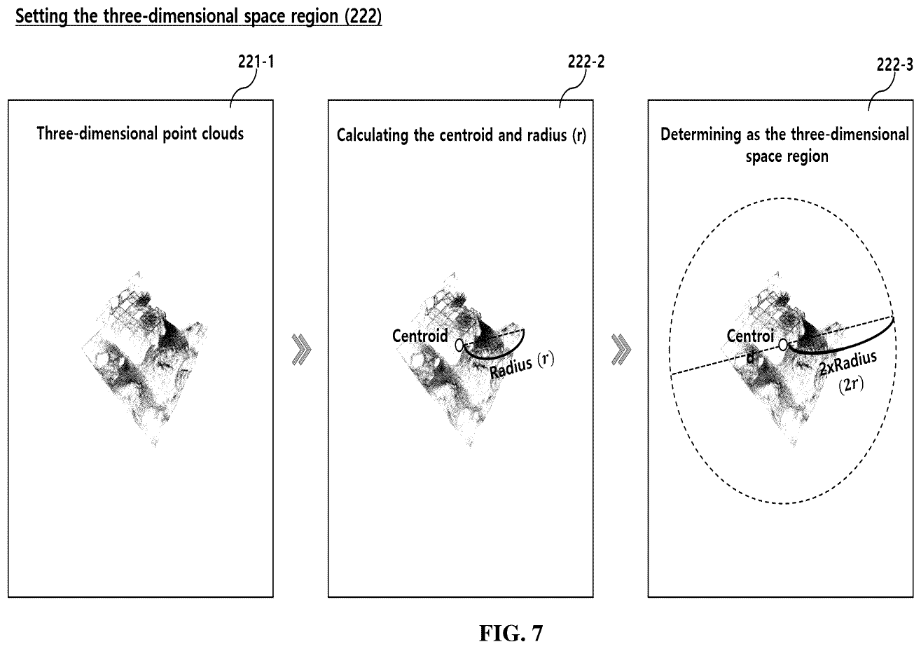

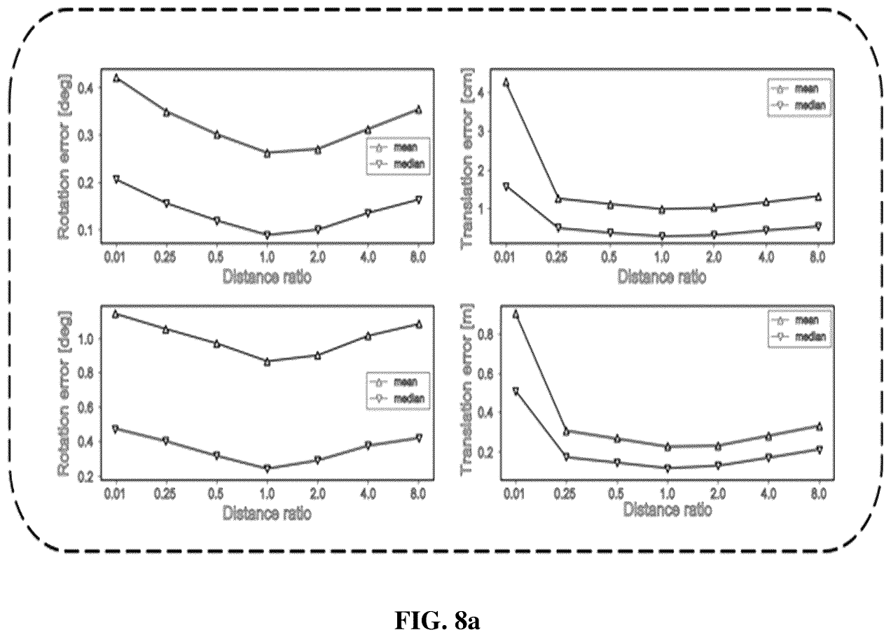

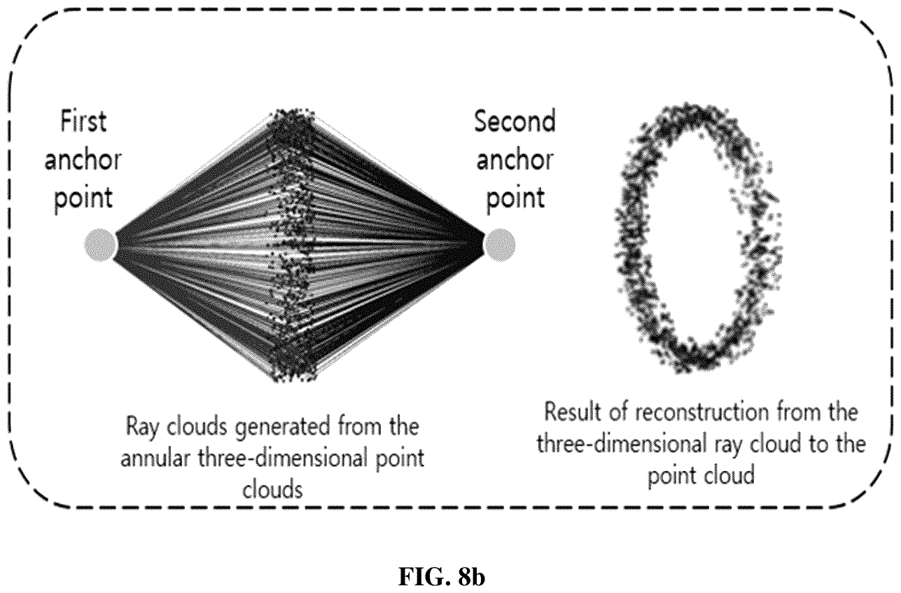

FIG. 5 is a flowchart for specifically describing a second embodiment of the step of generating the anchor points. FIG. 6 is a diagram for describing a first embodiment of setting a three-dimensional space region, and FIG. 7 is a diagram for describing a second embodiment of setting a three-dimensional space region. FIGS. 8a and 8b are a diagram for describing a basis for setting a three-dimensional space region. To avoid repetitive description, a description will be made together below.

Referring to FIG. 5, the system 1 sets a three-dimensional space region in which anchor points exist (220).

Unlike the first embodiment (FIG. 4), the step of generating the anchor points (200) generates a candidate region, i.e., a three-dimensional space region, in which candidate anchor points may be generated in advance, and generates candidate anchor points that serve as candidates for the anchor points in the three-dimensional space region. The system 1 may include the first embodiment (see FIG. 6) and the second embodiment (see FIG. 7) in setting the three-dimensional space region.

Referring to FIG. 6, the system 1 may perform principal component analysis (PCA) 221-2 of the three-dimensional point clouds 221-1. Here, PCA (principal component analysis) is a technique used for dimensionality reduction, and is used in machine learning, data mining, statistical analysis, and denoising. In other words, the system 1 changes high-dimensional data included in the three-dimensional point clouds into low-dimensional data.

Specifically, the system 1 calculates three basis axes v₁, v₂, and v₃ and variances σ₁, σ₂, and σ₃ for each axis through PCA. The system 1 may set a region that is two sigma (2×σ₁, 2×σ₂, 2×σ₃) away for each basis axis based on the centroid as the three-dimensional space region 221-3.

Further, the setting criterion for the three-dimensional space region is shown as 2 sigma in the embodiment of FIG. 6 but is not necessarily limited thereto, and may be changed to various values such as 1.96 sigma.

Referring to FIG. 7, the system 1 may calculate (222-2) the centroid and radius r of the three-dimensional points included in the three-dimensional point clouds 221-1. Specifically, the system 1 may calculate the distance between the centroid and the three-dimensional points, and set the region within twice the radius 2r from the centroid as the three-dimensional space region, with the farthest distance from the centroid being the radius r.

Further, the setting criterion for the three-dimensional space region is shown as twice the radius in the embodiment of FIG. 7 but is not necessarily limited thereto, and may be changed to various values.

The greater the distance ratio between the at least two or more anchor points gets, the more parallel to each other the generated ray clouds can become. In this case, the accuracy of the pose estimation of the camera 11 can be weakened. Referring to graph FIG. 8a, it can be seen that as the distance ratio between the two anchor points increases, the rotation and translation errors increase.

In addition, the greater the distance ratio between the anchor points gets, the higher the accuracy of reconstructing the point clouds from the three-dimensional ray clouds can be. Referring to FIG. 8b, it can be seen that the farther away the two anchor points (anchor point 1, anchor point 2) from each other in the annular three-dimensional point clouds, the more similar the reconstructed point clouds become to the original three-dimensional point cloud. Therefore, by setting the region where the anchor points can exist to a space region that is not too far from the three-dimensional point cloud, the disclosed system 1 can lower the accuracy of reverse reconstruction (protecting personal privacy) while maintaining the accuracy of the pose estimation of the camera.

Referring again to FIG. 5, the system 1 samples candidate anchor points (230).

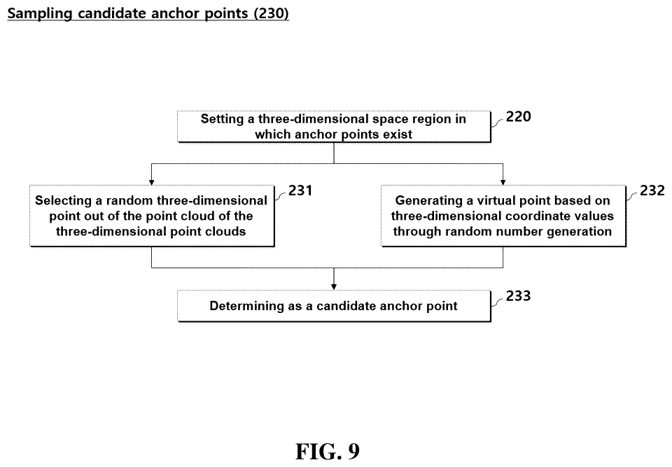

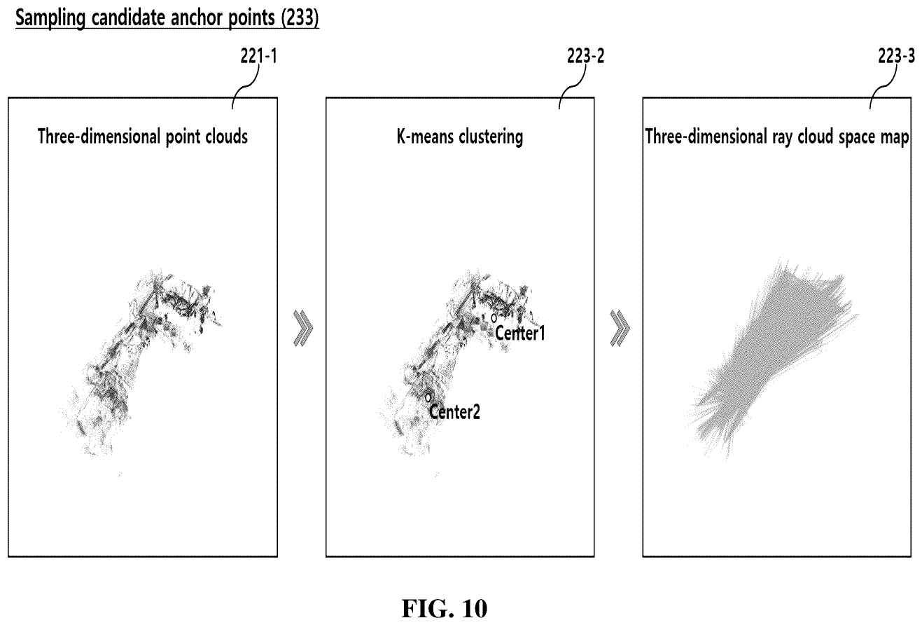

The method of generating the candidate anchor points will be specifically described through FIGS. 9 and 10.

The system 1 determines whether the sampled candidate anchor points exist in the set three-dimensional space region (240).

If the candidate anchor points are not included in the set three-dimensional space region (No in 240), the system 1 discards the previous candidate anchor points and generates candidate anchor points again (230).

If the candidate anchor points are included in the set three-dimensional space region (Yes in 240), the system 1 determines the candidate anchor points as the anchor points for the generation of ray clouds (250).

FIG. 9 is a flowchart for specifically describing the step of sampling the candidate anchor points included in FIG. 5.

Referring to FIG. 9, the system 1 may select a random three-dimensional point out of the point cloud of the three-dimensional point clouds included in the set three-dimensional space region (231). In addition, the system 1 may generate a virtual point based on three-dimensional coordinate values through random number generation out of the point cloud of the three-dimensional point clouds included in the set three-dimensional space region (232).

The three-dimensional point generated in step 231 or step 232 is sampled as a candidate anchor point (233).

Here, the coordinates of the virtual point in step 232 refer to a random point generated as a result of random number generation. The system 1 determines whether the generated virtual point is present in the three-dimensional space region (step 240 in FIG. 5). If the virtual point is not present in the three-dimensional space region, the virtual point is discarded, and a new virtual point is generated again through random number generation. If the virtual point is included in the three-dimensional space region, the system 1 determines it as a candidate anchor point.

FIG. 10 is a diagram showing one example in which ray clouds have been generated based on point clouds.

If only one anchor point is set by setting one candidate anchor point, visual localization may suffer from the problem of an increase in translation errors. The system 1 solves the problem of an increase in translation errors by setting three-dimensional points in the three-dimensional point clouds or a plurality of virtual points included in the three-dimensional space region as candidate anchor points and setting at least two or more anchor points.

In the embodiment of FIG. 10, clusters may be set (233-2) through the K-means clustering algorithm, and the center points (center 1, center 2) in the clusters may be generated as anchor points, unlike the embodiment of FIG. 9. The system 1 generates ray clouds based on the two anchor points (233-3).

In the case of the embodiment of FIG. 10, since the clusters are always present in the three-dimensional space region mentioned in FIG. 5 through the K-means clustering algorithm, it may not be necessary to set a three-dimensional space region separately.

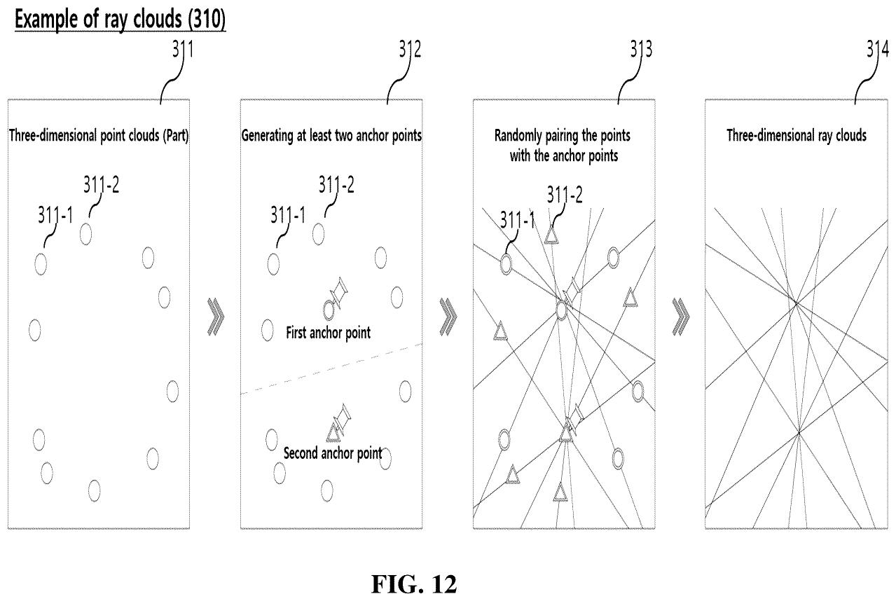

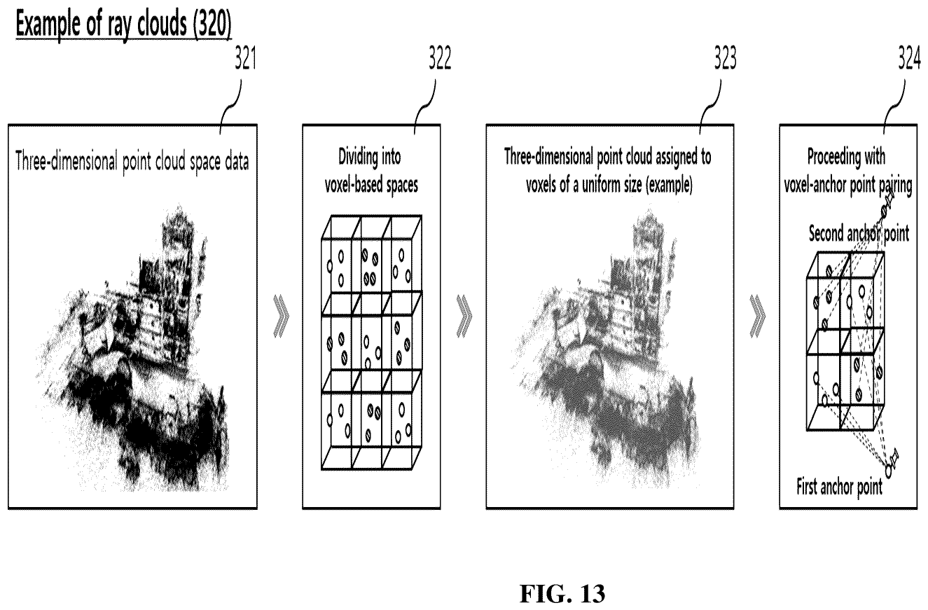

FIG. 11 is a flowchart for describing a specific method of generating ray clouds. FIG. 12 is a diagram for describing a first embodiment of generating ray clouds. FIG. 13 is a diagram for describing a second embodiment of generating ray clouds. To avoid repetitive description, a description will be made together below.)

Referring to FIG. 11, the system 1 determines at least two or more anchor points (301).

The method of determining the anchor points is executed in the method described through FIGS. 4 to 10.

After the at least two or more anchor points are generated, the system 1 may pair one randomly selected three-dimensional point with one of the at least two or more anchor points (310).

Referring to FIG. 12, the system 1 generates at least two anchor points (312) from the three-dimensional point clouds 311.

The diagrams in FIG. 12 are shown in two dimensions for ease of understanding, but the respective diagrams are all made in three dimensions.

The system 1 randomly pairs the three-dimensional points with the anchor points (313) and generates ray clouds connecting the paired three-dimensional points and anchor points (314).

Specifically, the system 1 generates a line connecting a first anchor point and a random point 311-1 of the three-dimensional point clouds. In addition, the system 1 generates a line connecting a second anchor point and another random point 311-2 of the three-dimensional point clouds. At this time, the respective random points 311-1 and 311-2 may all be determined randomly.

The system 1 connects all of the three-dimensional points in the three-dimensional point clouds 311 and the anchor points by repeating the process described above. The ray cloud generated in this way has a geometric property that the lines generated from different anchor points intersect each other.

Referring again to FIG. 9, unlike step 310, the system 1 may divide the three-dimensional point clouds into subspace regions having a preset size (320), and pair all three-dimensional points included in one subspace region of a plurality of divided subspace regions with one of the at least or more two anchor points (321).

Here, the subspace regions are three-dimensional regions obtained by dividing the three-dimensional point clouds (or three-dimensional point cloud space data), and the size (or volume) and shape of the regions may vary. As one example, the subspace regions may be formed of voxels that divide the three-dimensional point cloud space data evenly, but are not limited thereto. In other words, the subspace regions may also be formed by a method of dividing the three-dimensional space unequally.

The system 1 may proceed with anchor point pairing by using voxels as in FIG. 13 when dividing the three-dimensional point clouds into subspace regions.

The system 1 may divide the three-dimensional point clouds 321 into voxel-based spaces (322).

Specifically, the system 1 can distinguish the three-dimensional point clouds by displaying the three-dimensional point clouds assigned to the voxels in different colors and contrasts as in 323 in FIG. 13.

The system 1 pairs three-dimensional points included in the respective regions divided into voxels with each anchor point (324).

Unlike step 310 in FIG. 11, which randomly connects the anchor points and the three-dimensional points, the system 1 may also pair each anchor point based on the voxel. The ray cloud generated in this way has a geometric property that the lines generated from different anchor points intersect each other, and as a geometric property that adjacent points are connected to the same anchor point is added, there is an effect of lowering the accuracy of reverse reconstruction to the point clouds.

Referring again to FIG. 11, the system 1 generates lines (330) by connecting the three-dimensional points and anchor points for which pairing is completed, and deletes the three-dimensional points from which the lines have been generated (340), thereby finally generating ray clouds.

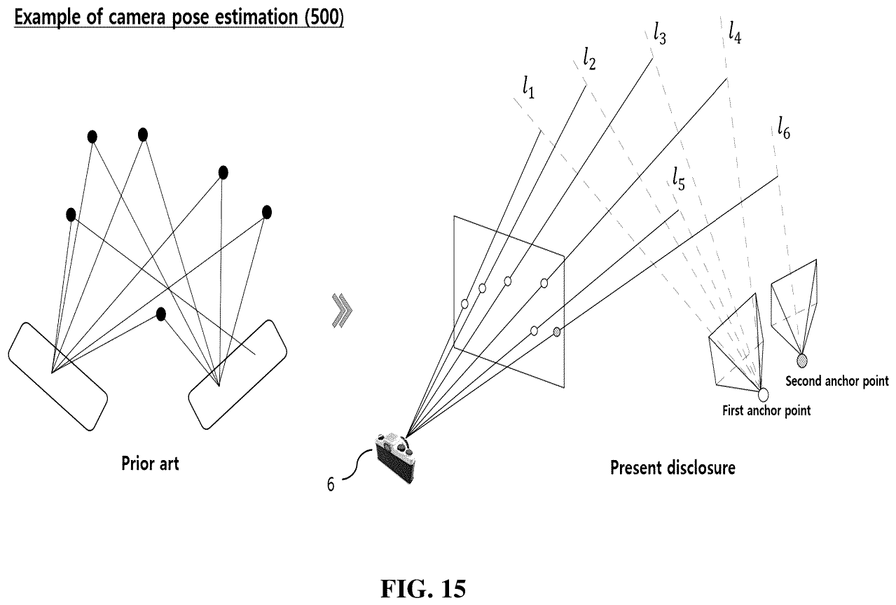

FIG. 14 is a flowchart for describing a specific method for performing pose estimation of a camera. FIG. 15 is a diagram for specifically describing the disclosed visual localization method.

Referring first to FIG. 14, the system 1 loads the three-dimensional ray clouds (510).

Here, the three-dimensional ray clouds are ray clouds generated through the anchor point generation and the pairing of the anchor points (step 300 of FIG. 3). The generated ray clouds are stored via the memory 23.

If the server 20 performs the pose estimation of the camera 11 according to one disclosed embodiment (FIG. 2a), the server 20 uses the ray clouds generated through the pairing of the anchor points. However, if the user terminal 10 performs the pose estimation of the camera 11 according to another embodiment (FIG. 2b), the server 20 loads the three-dimensional ray clouds stored via the memory 23, etc., and transmits the generated ray clouds to the user terminal 10.

The system 1 extracts feature points of the input image (520).

Here, the feature points may include not only the feature points but also the feature information of the input image. The feature information may include both line features and color information. If the server 20 performs the pose estimation of the camera 11 according to one disclosed embodiment, the user terminal 10 extracts feature points from the input image and transmits them to the server 20. If the user terminal 10 performs the pose estimation of the camera 11 according to another disclosed embodiment, the user terminal 10 extracts feature points and executes the following steps.

The system 1 matches the correspondence between the feature points and the lines included in the ray clouds (530).

Specifically, the system 1 performs one-to-one matching between the feature points extracted from the input image and the straight lines (lines) included in the ray clouds through feature descriptors.

As will be described later, the straight line matched with the feature point may be included in one of multiple clusters of ray clouds, and each feature point may have a correspondence with an anchor point of the ray cloud including the matched straight line. Therefore, the system 1 will be able to estimate the camera pose by using a location estimation algorithm between virtual perspective cameras (hereinafter, corresponding to the anchor points).

The system 1 clusters ray clouds according to the anchor points out of a plurality of lines matched with the feature points (540), and the server 20 samples two ray cloud clusters out of the clustered results (550).

Specifically, the system 1 proceeds with clustering based on the at least two or more anchor points. Referring to FIG. 15, the system 1 clusters at least five or more lines from the at least two or more anchor points (first anchor point, second anchor point). The system 1 proceeds with visual localization based on a camera 11 perspective and at least two or more clustered anchor point perspectives, i.e., three perspectives.

For the pose estimation of the camera 11 using a three-dimensional line cloud space map, the prior art proposed a P6L (Point-6-Line) algorithm based on a method of estimating relative locations between generalized camera models. In contrast to the prior art, the disclosed system 1 can significantly improve the calculation speed while maintaining the localization accuracy based on the relative location estimation method of the pinhole camera model instead of the general camera model.

Referring again to FIG. 14, the system 1 estimates the pose of the camera 11 based on the sampled ray cloud clusters (560).

Specifically, the system 1 regards each anchor point (the first anchor point and the second anchor point in FIG. 15) as the center of the virtual perspective (or pinhole) camera model. In other words, when applying the sampled ray cloud clusters to the algorithm of the pinhole camera model, the system 1 proceeds with the pose estimation of the camera based on each anchor point set in the clustering process. Thereby, the disclosed system 1 can improve the camera pose estimation time from the existing 3 frames/sec (fps) to at least 100 frames/sec.

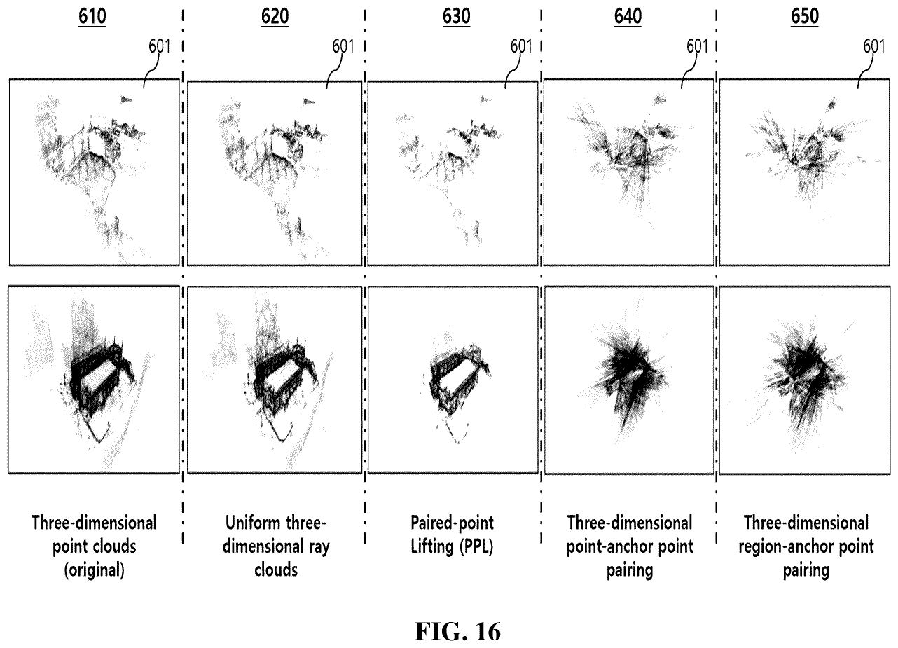

FIG. 16 is a diagram for comparing the ray clouds generated by each embodiment according to the same input image.

Referring to FIG. 16, views 610, 620, and 630 are the results 611, 612, and 613 obtained by reversely reconstructing the three-dimensional point clouds 601 of the input image with the prior art. Specifically, 610 is the result of reverse reconstruction without transformation of the line clouds, 620 is the result of reverse reconstruction through Prior Art Literature 1, and 630 is the result of reverse reconstruction through Prior Art Literature 3. In particular, only 50% of the three-dimensional point cloud is reconstructed in 630, but the geometric error of the reconstructed point cloud from the original is small.

Using the prior art, since the results of the geometric reconstruction to the three-dimensional point clouds 601 are visually perceptible and detailed image synthesis for spatial information is possible in the case of three-dimensional uniform line clouds, there is a limitation in the spatial information security.

Next, 640 is the result of reverse reconstruction through the ray clouds generated by pairing the three-dimensional points with the anchor points, and 650 is the result of reverse reconstruction through the ray clouds generated by pairing the three-dimensional regions (voxels) with the anchor points.

It can be seen that the ray clouds based on the anchor points for the disclosed visual localization method cause mis-reconstruction and has a large geometric error in the geometric reconstruction based on the line density due to the high line density around the anchor points when reversely reconstructing to the point clouds.

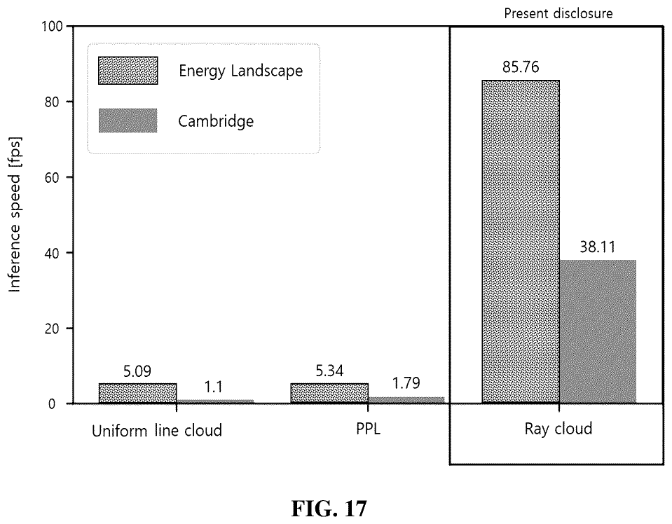

FIG. 17 is a table for describing the effect of the disclosed visual localization method.

The x-axis of the table in FIG. 17 distinguishes between the present disclosure and the prior art, and the y-axis represents the inference speed (fps). This comparative experiment shows the reconstruction calculation speed for images captured indoors (Cambridge) and outdoors (energy landscape).

Referring to FIG. 17, the prior art (uniform line cloud) using line data had calculation speeds of 5.09 and 1.1 fps, and the PPL technique disclosed in Prior Art Literature 3 showed calculation speeds of 5.34 and 1.79 fps. In contrast, the reverse reconstruction using the ray clouds of the present disclosure (Ray cloud) recorded 85.76 and 38.11 fps, showing a calculation speed increase rate of up to 35 times.

As a result, the disclosed visual localization method based on 3D ray clouds and the apparatus for executing the same show a higher calculation speed than the conventional single-image visual localization algorithm using line clouds, and can thus be applied to various products requiring real-time calculations. In particular, the disclosed embodiments are applicable to products in which real-time visual localization for immediate interaction with the surrounding environment is essential, such as in the fields of autonomous driving and robotics, and can maintain high spatial information security by preventing attempts to reconstruct three-dimensional point clouds from a three-dimensional ray cloud map.

As the present disclosure can be implemented in other specific forms without changing its technical idea or essential features, those skilled in the art to which the present disclosure pertains should understand that the embodiments described above are illustrative and not restrictive in all respects. The scope of the present disclosure is indicated by the claims set forth below rather than the detailed description above, and all changes or modifications derived from the meaning and scope of the claims and their equivalent concepts should be construed as falling within the scope of the present disclosure.

### DESCRIPTION OF REFERENCE SYMBOLS

1: System
2: Communication network
10: User terminal
11: Camera
12, 22: Communication unit
14: Output unit
20: Server
21: Input unit
13, 23: Memory
15, 25: Processor
26: Anchor point generation unit
27: Three-dimensional ray cloud generation unit
28: Visual localization unit

1. A visual localization method comprising:
generating at least two or more anchor points from three-dimensional point clouds;
generating three-dimensional ray clouds by connecting three-dimensional points included in the three-dimensional point clouds with one of the generated anchor points;
extracting feature points of an input image; and
clustering a plurality of lines included in the three-dimensional ray clouds based on the at least two or more anchor points, sampling two ray cloud clusters out of the clustered ray cloud clusters, and estimating a pose of a camera that captured the input image based on the sampled ray cloud clusters and the feature points.

2. The visual localization method of claim 1, wherein the generating the anchor points comprises:
storing a setting command for the number of the anchor points to be generated;
generating clusters as many as the number of the anchor points from the three-dimensional point clouds;
extracting center points of the generated clusters; and
generating the extracted center points as the anchor points.

3. The visual localization method of claim 1, wherein the generating the anchor points comprises:
setting a three-dimensional space region in which anchor points exist from the three-dimensional point clouds;
sampling candidate anchor points; and
generating the anchor points based on whether the candidate anchor points exist in the three-dimensional space region.

4. The visual localization method of claim 3, wherein the setting the three-dimensional space region comprises:
calculating three basis axes and variances for the basis axes based on principal component analysis of the three-dimensional point clouds; and
setting the three-dimensional space region based on the calculated variances.

5. The visual localization method of claim 3, wherein the setting the three-dimensional space region comprises:
calculating a centroid of a three-dimensional point included in the three-dimensional point clouds; and
setting the three-dimensional space region by setting a distance between the centroid and the three-dimensional point as a radius.

6. The visual localization method of claim 3, wherein the sampling the candidate anchor points comprises:
selecting a random three-dimensional point from the three-dimensional point clouds; or
sampling the candidate anchor points based on three-dimensional coordinate values generated through random number generation.

7. The visual localization method of claim 1, wherein the generating the three-dimensional ray clouds comprises:
pairing one three-dimensional point randomly selected from the three-dimensional points included in the three-dimensional point clouds with one of the at least two or more anchor points;
generating a line connecting the paired three-dimensional point and anchor point with each other; and
deleting the three-dimensional point from which the line was generated.

8. The visual localization method of claim 1, wherein the generating the three-dimensional ray clouds comprises:
dividing the three-dimensional point clouds into a plurality of subspace regions having a preset size;
pairing all three-dimensional points included in one of the subspace regions with one of the at least two or more anchor points;
generating lines connecting the paired three-dimensional points and anchor point; and
deleting the three-dimensional points from which the lines were generated.

9. The visual localization method of claim 1, wherein the ray cloud clusters are characterized in that the one anchor point intersects at least five or more lines.

10. A server comprising:
a processor; and
a memory configured to store a program for operating the processor and three-dimensional point clouds received from outside,
wherein the processor:
generates at least two or more anchor points from the three-dimensional point clouds,
generates three-dimensional ray clouds by connecting three-dimensional points included in the three-dimensional point clouds with one of the generated anchor points;
clusters a plurality of lines included in the three-dimensional ray clouds based on the at least two or more anchor points,
samples two ray cloud clusters out of the clustered ray cloud clusters, and
estimates a pose of a camera that captured the input image based on the sampled ray cloud clusters and feature points of an input image.

11. The server of claim 10, wherein the processor:
receives a setting command for the number of the anchor points, generates clusters as many as the number of the anchor points from the three-dimensional point clouds, extracts center points of the generated clusters, and generates the extracted center points as the anchor points, or
sets a three-dimensional space region in which anchor points exist from the three-dimensional point clouds, samples candidate anchor points, and generates the anchor points based on whether the candidate anchor points exist in the three-dimensional space region.

12. The server of claim 11, wherein the processor:
calculates three basis axes and variances for the basis axes based on principal component analysis of the three-dimensional point clouds, and sets the three-dimensional space region based on the calculated variances, or
calculates a centroid of a three-dimensional point included in the three-dimensional point clouds, and sets the three-dimensional space region by setting a distance between the centroid and the three-dimensional point as a radius, and
selects a random three-dimensional point from the three-dimensional point clouds, or samples the candidate anchor points based on three-dimensional coordinate values generated through random number generation.

13. The server of claim 10, wherein the processor:
pairs one three-dimensional point randomly selected from the three-dimensional points included in the three-dimensional point clouds with one of the at least two or more anchor points,
generates a line connecting the paired three-dimensional point and anchor point with each other, and
deletes the three-dimensional point from which the line was generated.

14. The server of claim 10, wherein the processor:
divides the three-dimensional point clouds into a plurality of subspace regions having a preset size,
pairs all three-dimensional points included in one of the subspace regions with one of the at least two or more anchor points,
generates lines connecting the paired three-dimensional points and anchor point with each other, and
deletes the three-dimensional points from which the lines were generated.

15. A system comprising:
a user terminal configured to capture an input image; and
a server configured to communicate with the user terminal,
wherein the server:
generates at least two or more anchor points from three-dimensional point clouds,
generates three-dimensional ray clouds by connecting three-dimensional points included in the three-dimensional point clouds with one of the generated anchor points, and
clusters a plurality of lines included in the transmitted three-dimensional ray clouds based on the at least two or more anchor points, and samples at least two ray cloud clusters out of the clustered ray cloud clusters, and
wherein the user terminal:
detects feature points of the input image, and
estimates a pose of a camera that captured the input image based on the detected feature points, the at least two or more anchor points set as a center of a pinhole camera model, and the sampled ray cloud clusters.
